(19) United States
(12) Patent Application Publication
(10) Pub. No.: US 2026/0118902 A1
(43) Pub. Date: Apr. 30, 2026

(54) CIRCUITRY TO REDUCE RESIDUAL VOLTAGE OF ELECTRONIC COMPONENT AND ELECTRONIC DEVICE COMPRISING SAME

(71) Applicant: Samsung Electronics Co., Ltd., Suwon-si (KR)

(72) Inventors: Keonwoo KIM, Suwon-si (KR); Moonyoung KIM, Suwon-si (KR); Jungho LEE, Suwon-si (KR); Jinhyung LEE, Suwon-si (KR)

(21) Appl. No.: 19/273,534

(22) Filed: Jul. 18, 2025

Related U.S. Application Data
(63) Continuation of application No. PCT/KR2025/009852, filed on Jul. 8, 2025.

(30) Foreign Application Priority Data
Oct. 30, 2024 (KR) 10-2024-0151530

(51) Int. Cl. G05F 3/18; G05F 1/46; G05F 1/56; H02J 3/00

(52) U.S. Cl. CPC G05F 3/185; G05F 1/463; G05F 1/562; H02J 3/001

(57) ABSTRACT

An electronic device includes an electronic component. The electronic device includes a thermistor. A resistance of the thermistor is increased by a temperature of the thermistor being increased. The electronic device includes a switch configured to connect the thermistor to a node being included in a power path to transmit a power signal to the electronic component. The electronic device includes control circuitry configured to control the switch. The control circuitry is configured to, based on deactivation of the electronic device, connect the thermistor to the node by controlling the switch to reduce the power signal transmitted through the power path. The control circuitry is configured to control the switch such that a voltage of the thermistor connected to the node is maintained to be lower than or equal to a reference voltage.

### CROSS-REFERENCE TO RELATED APPLICATIONS

This application is a continuation of International Application No. PCT/KR2025/009852 designating the United States, filed on Jul. 8, 2025, in the Korean Intellectual Property Receiving Office and claiming priority to Korean Patent Application No. 10-2024-0151530, filed on Oct. 30, 2024, in the Korean Intellectual Property Office, the disclosures of each of which are incorporated by reference herein in their entireties.

### BACKGROUND

### Field

The disclosure relates to circuitry to reduce a residual voltage of an electronic component and an electronic device including the same.

### Description of Related Art

An electronic device may receive a power signal from an infrastructure to provide power, referred to as a distribution system. The electronic device receiving the power signal may execute various functions based on a design of the electronic device based on the power signal. The power signal received by the electronic device is an alternate current signal. The electronic device may include circuitry (e.g., power circuitry) to obtain a direct current signal to be applied to electronic components corresponding to the functions from the alternate current signal. In the electronic device such as a TV, an electronic component (e.g., a display panel) to output an image may require a direct current signal with a voltage of several tens of V or more for driving. The voltage applied to the electronic component may be reduced at a slow speed or maintained by electrical energy stored in a circuitry element (e.g., a capacitor and/or an inductor) in the electronic component even after the electronic device is turned off. When a user touches the turned-off electronic device, the voltage of the electronic component may be applied to the user in a case that the voltage of the electronic component is not 0 V.

The above-described information may be provided as a related art for the purpose of helping understanding of the present disclosure. No assertion or determination is made as to whether any of the above description may be applied as a prior art related to the present disclosure.

### SUMMARY

According to an example embodiment, an electronic device may comprise an electronic component comprising circuitry. The electronic device may comprise a thermistor. A resistance of the thermistor may be configured to be increased based on a temperature of the thermistor being increased. The electronic device may comprise a switch configured to connect the thermistor to a node being included in a power path configured to transmit a power signal to the electronic component. The electronic device may comprise control circuitry configured to control the switch. The control circuitry may be configured to, based on deactivation of the electronic device, connect the thermistor to the node by controlling the switch to reduce the power signal transmitted through the power path. The control circuitry may be configured to control the switch such that a voltage of the thermistor connected to the node is maintained to be lower than or equal to a reference voltage.

According to an example embodiment, a method of operating an electronic device may be provided. The electronic device may comprise an electronic component comprising circuitry, a thermistor, and a switch configured to control an electric connection associated with the thermistor. The method may comprise receiving an input to deactivate the electronic device. The method may comprise controlling, based on the input, the switch such that a power signal transmitted to the electronic component is transmitted to the thermistor. The method may comprise controlling, while the power signal is transmitted to the thermistor, the switch such that a voltage of the power signal transmitted to the thermistor is maintained to be lower than or equal to a reference voltage.

According to an example embodiment, an electronic device may comprise power circuitry. The electronic device may comprise an electronic component. The electronic device may comprise a thermistor. A resistance of the thermistor may be configured to be increased based on a temperature of the thermistor being increased. The electronic device may comprise a switch configured to connect the thermistor to a node included in a power path to transmit a power signal from the power circuitry to the electronic component. The electronic device may comprise control circuitry configured to control the switch. The control circuitry may be configured to, in a first state to activate the electronic component, control the switch such that the thermistor is electrically disconnected from the power path. The control circuitry may be configured to, in a second state different from the first state, control the switch such that a voltage of the thermistor is maintained to be lower than or equal to a reference voltage.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an electronic device according to various embodiments;

FIG. 2 is a block diagram illustrating an example configuration of an electronic device according to various embodiments;

FIG. 3 is a circuit diagram illustrating an example configuration of discharge circuitry included in an electronic device according to various embodiments;

FIG. 4 includes graphs illustrating a voltage and/or a current of a node and/or a circuitry element in an electronic device associated with discharge circuitry according to various embodiments;

FIG. 5 is a circuit diagram illustrating an example configuration of discharge circuitry including a shunt regulator according to various embodiments;

FIG. 6 is a circuit diagram illustrating example discharge circuitry included in an electronic device according to various embodiments;

FIG. 7 is a circuit diagram illustrating example discharge circuitry included in an electronic device according to various embodiments;

FIG. 8 is a circuit diagram illustrating example discharge circuitry included in an electronic device according to various embodiments; and

FIG. 9 is a circuit diagram illustrating example discharge circuitry included in an electronic device according to various embodiments.

### DETAILED DESCRIPTION

Hereinafter, various example embodiments of the present disclosure will be described in greater detail with reference to the accompanying drawings.

The various example embodiments of the present disclosure and terms used herein are not intended to limit the scope of the present disclosure to specific embodiments, and should be understood to include various modifications, equivalents, or substitutes of the various example embodiments. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware, software, or firmware, or any combination thereof, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

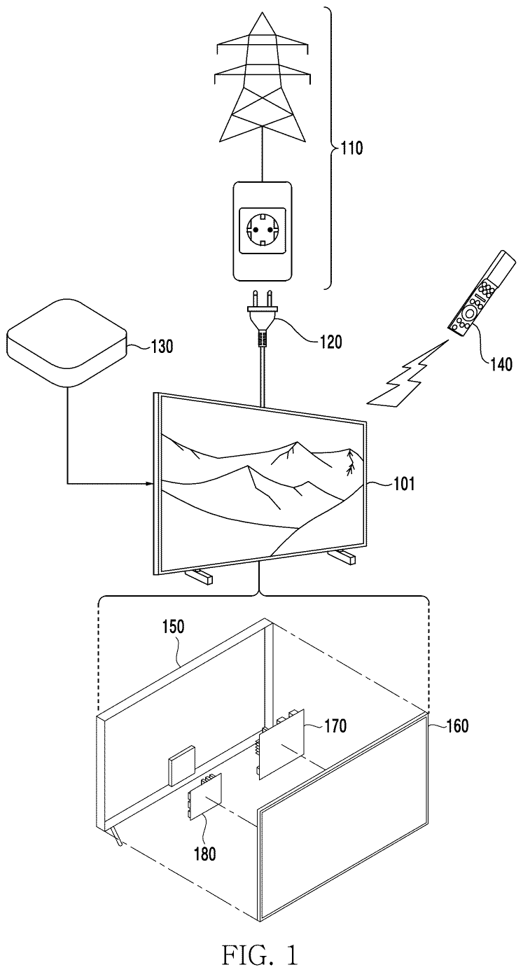

FIG. 1 is a diagram illustrating an example electronic device 101 according to various embodiments. The electronic device 101 may be described as an electronic device capable of displaying an image. For example, the electronic device 101 may include, without limitation, a television (TV), a monitor, a computer, a smartphone, a tablet PC, a portable media player, a wearable device, a video wall, an electronic frame, or the like. The electronic device 101 may be referred to as a display device. Hereinafter, for convenience of a description, the disclosure will be described on assumption that the electronic device 101 is implemented as the TV, but is the disclosure is not limited thereto.

The electronic device 101 may be configured to operate by power (e.g., an alternate current (AC) power signal, and/or an alternate current signal) provided from a power system 110. The power system 110 (or a distribution system) may be described as an infrastructure built to provide the power. The electronic device 101 may include a plug 120 (or a port or an electrical cord) configured to be connected to a power point (or an outlet, a socket, or a receptacle) positioned in an end of the power system 110. The plug 120 may be connected to a component (e.g., an AC-DC adapter (or an electrical adapter) and/or power circuitry 170) of the electronic device 101 for power conversion (e.g., power conversion from an alternate current signal to a direct current (DC) signal (or a direct current power signal)).

While the plug 120 is electrically connected to the power system 110, the electronic device 101 may execute a function to output an image, sound, or a combination thereof (e.g., multimedia content) based on the power of the power system 110. When the electronic device 101 receives information indicating the image and/or the sound, the electronic device 101 may execute the function using the information. The information indicating the image and/or the sound may be stored in the electronic device 101 or received from an external electronic device (e.g., a set-top box (STB)) 130 connected to the electronic device 101. The electronic device 101 may include an antenna configured to receive the information wirelessly, or may be electrically connected to the antenna.

The electronic device 101 while receiving the power of the power system 110 through the plug 120 may be driven according to any one of a normal mode (or an active mode, an enabled mode), and a standby mode (or an inactive mode, a disabled mode, a hibernate mode, and a sleep mode). The normal mode may be described as a mode that consumes power greater than power consumption (e.g., standby power) of the standby mode to output an image. The mode of the electronic device 101 is not limited to the normal mode and the standby mode. In the present disclosure, a term “mode” may be used interchangeably with a term “state”. In the standby mode, an output of the image and the sound by the electronic device 101 may be substantially stopped, or may be minimized/reduced. In the standby mode, the electronic device 101 may output a message (e.g., “press a power button”) guiding an input to switch to the normal mode. The message may be output through a display and/or a speaker of the electronic device 101. In the normal mode, the electronic device 101 may output an image (e.g., an image different from the message) and/or sound. The electronic device 101 may convert or toggle between the standby mode and the normal mode, based on a user input.

The electronic device 101 may include hardware to receive an input (e.g., the user input to convert between the standby mode and the normal mode) for control of the electronic device 101. For example, the electronic device 101 may include a switch (or a button) that is at least partially visible through a housing of the electronic device 101. For example, the electronic device 101 may include a touch sensor (e.g., a pressure sensitive touch sensor and/or a capacitive touch sensor) to detect a touch input on at least a portion of the housing. The user input may include a direct action (e.g., an action of pressing the switch and/or the button or touching a surface of the housing) of a user on the electronic device 101. The disclosure is not limited thereto, and the user input may be identified by an audio signal indicating a speech of the user received through a microphone. The disclosure is not limited thereto, and the user input may include an indirect action of the user associated with the electronic device 101, based on a remote controller 140.

Referring to FIG. 1, the electronic device 101 may be configured to receive a wireless signal (or an optical signal) of the remote controller 140 based on infrared (IR). An embodiment is not limited thereto, and the remote controller 140 may be configured to transmit a wireless signal based on Bluetooth, Bluetooth low energy (BLE), near-field communication (NFC), ultra-wideband (UWB), wireless fidelity (WiFi), WiFi-direct, and/or another wireless short-range communication protocol. For example, the electronic device 101 may be configured to receive the wireless signal based on the exemplified wireless short-range communication protocol. In both the standby mode and the normal mode, the electronic device 101 may be configured to receive the wireless signal of the remote controller 140.

FIG. 1 includes an exploded perspective view illustrating electronic components included in the electronic device 101. The electronic device 101 may include a housing 150, a display panel 160, the power circuitry 170, and main circuitry 180. The housing 150 may include a rear cover (or a rear surface cover or a back cover) of the electronic device 101. The housing 150 may include an object (e.g., a support leg and/or video electronics standards association (VESA) mount holes) to support the electronic device 101. A surface of the electronic device 101 that the housing 150 is visible may be described as the rear surface (e.g., a rear side) of the electronic device 101.

Another surface of the electronic device 101 opposite to the surface of the electronic device 101 that the housing 150 is visible may be described as a front surface (e.g., a front side) of the electronic device 101. The display panel 160 may be visible from the front surface of the electronic device 101. The display panel 160 may include a liquid crystal display (LCD), a plasma display panel (PDP), and a plurality of LEDs. The LED of the display panel 160 may include an organic LED (OLED). In an embodiment, the display panel 160 may include electronic paper. In a case that the display panel 160 has a planar shape, the display panel 160 may be referred to as a flat panel display (FPD). In a case that the display panel 160 has a curved shape, the display panel 160 may be referred to as a curved display. In a case that the display panel 160 has a deformable shape, the display panel 160 may be referred to as a bendable display, a flexible display, and/or a rollable display.

The main circuitry 180 may be configured to execute a function (e.g., a function to output an image, sound, or a combination thereof, a turn-on function, a turn-off function, a function to adjust volume, a function to change a channel, and/or a function to control execution of a software application (an over the top (OTT) application) installed in electronic device 101) of the electronic device 101 described above. For example, the main circuitry 180 may output an image, a video, or any combination thereof indicated by information, by controlling the display panel 160 using the information received from the external electronic device 130 (or the antenna of the electronic device 101). For example, the main circuitry 180 may be configured to control the display panel 160. The disclosure is not limited thereto, and the main circuitry 180 may output an audio signal indicated by the information, by controlling another electronic component (e.g., a speaker) different from the display panel 160.

The power circuitry 170 may be configured to provide power to the main circuitry 180. The power circuitry 170 may be configured to convert an alternate current signal received from the power system 110 into a direct current (DC) signal to drive the main circuitry 180. For example, the power circuitry 170 may be configured to transmit the direct current signal to the main circuitry 180. In addition to the main circuitry 180, the power circuitry 170 may transmit a power signal (e.g., a direct current signal having a voltage greater than or equal to several tens of V or more) to drive the display panel 160 to the display panel 160. For example, in the normal mode of the electronic device 101, the power circuitry 170 may transmit, to each of the main circuitry 180 and the display panel 160, a direct current with voltages required to drive each of the main circuitry 180 and the display panel 160.

Electronic components (e.g., the display panel 160, the power circuitry 170, and the main circuitry 180) of electronic device 101 may include at least one circuitry (or circuit) element (e.g., a capacitor, an inductor, and/or a filter component) configured to store electrical energy at least temporarily. In the normal mode, for driving and/or controlling an electronic component, the electrical energy may be accumulated or stored in the at least one circuitry element.

After the electronic device 101 is converted from the normal mode to the standby mode, the electrical energy stored in the at least one circuitry element may be released to the outside (e.g., another electronic component and/or the outside of the electronic device 101) of the at least one circuitry element. When the user contacts the electronic device 101 in the standby mode, an electrical shock of the user due to the electrical energy may occur when the electrical energy is transmitted to the user. After the electronic device 101 is converted to the standby mode, a voltage of at least one electronic component may have a voltage greater than 0 V by the electrical energy stored in the at least one circuitry (or circuit) element.

In the present disclosure, a residual voltage may refer to a voltage (e.g., a voltage greater than 0 V) remaining in the electronic device 101 and/or in an electronic component in the electronic device 101 after an electrical connection between the electronic device 101 and the power system 110 has ceased (or after the electronic device 101 is turned off). According to international electrotechnical commission (IEC) 60204, a residual voltage greater than 60 V may be required to be discharged (e.g., reduced to 0 V) within 5 seconds. According to the IEC 60204, a residual voltage less than 60 V may be required to be discharged within 1 second. In general, in a case that a charge of 60 mC or less is stored in the electronic device 101 and/or an electronic component, the residual voltage may be considered (completely) discharged or may be considered safe from an electric shock.

According to an embodiment, the electronic device 101 may include circuitry (e.g., discharge circuitry) to discharge the charge of an electronic component including the display panel 160 within a preset time. For example, the discharge circuitry may refer to circuitry configured to reduce the voltage of the electronic device 101 and/or the electronic component in electronic device 101 to substantially 0 V (or a threshold voltage or a target voltage). The discharge circuitry may be configured to discharge the charge of the electronic device 101 and/or the electronic component in the electronic device 101. After the electronic device 101 is turned off, the discharge circuitry may be included in the electronic device 101 and/or the electronic component to prevent the electric shock caused by the charge.

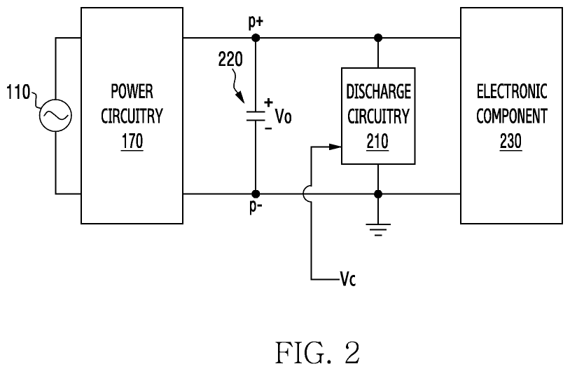

Hereinafter, an example of the discharge circuitry included in the electronic device 101 to remove or reduce the residual voltage of the electronic component will be described in greater detail with reference to FIG. 2.

FIG. 2 is a block diagram indicating an example configuration of an electronic device 101 according to various embodiments. The electronic device 101 of FIG. 1 may include the electronic device 101 of FIG. 2.

Referring to FIG. 2, an electronic device 101 may include an electronic component (e.g., including circuitry) 230. The main circuitry 180 and/or the display panel 160 of FIG. 1 may be an example of the electronic component 230 of FIG. 2. The electronic component 230 is not limited to the main circuitry 180 and/or the display panel 160 of FIG. 1, and may include any circuitry in the electronic device 101 capable of being driven by a direct current signal transmitted from the power circuitry 170 of FIG. 1.

Referring to FIG. 2, the electronic device 101 may include the power circuitry 170 configured to generate a direct current signal for driving the electronic component 230. The electronic device 101 may include a capacitor 220 positioned between the power circuitry 170 and the electronic component 230 for (stable) transmission of the direct current signal. In a port (e.g., a port including a node p+ and a node p−) between the electronic component 230 and the electronic device 101, the capacitor 220 may include an end connected to the node p+ of the port and another end connected to the node p− which is grounded. The capacitor 220 may be configured to at least temporarily store a power signal transmitted from the power circuitry 170. By the capacitor 220, a voltage of the port (e.g., a potential difference between the node p+ and the node p−) may be maintained at a constant voltage (e.g., a voltage required for driving the electronic component 230) (e.g., Vo). When receiving a direct current signal having the voltage, the electronic component 230 may perform an operation (or a function) based on the direct current signal. For example, the port may be at least partially included in a power path to transmit power to the electronic component 230.

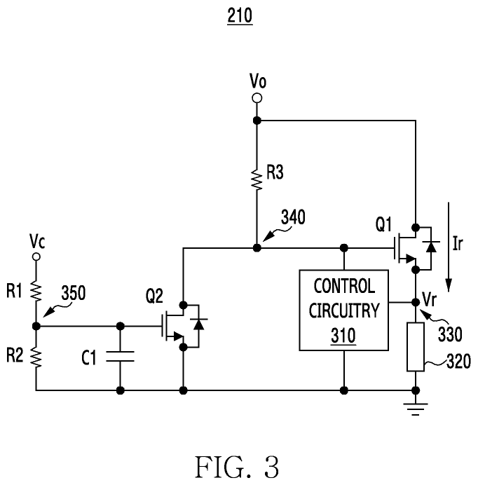

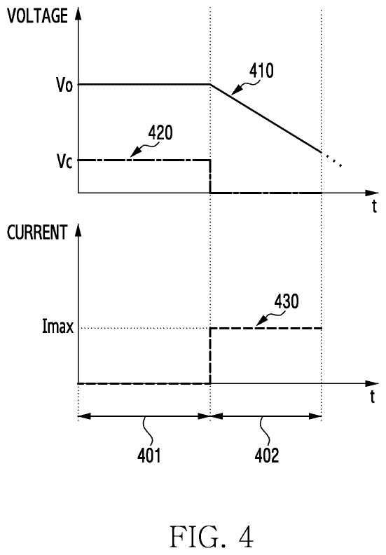

Referring to FIG. 2, the electronic device 101 may include discharge circuitry 210. The discharge circuitry 210 may be connected to the power path. The discharge circuitry 210 connected to the node p+ between the power circuitry 170 and the electronic component 230 may be configured to reduce or remove a voltage Vo (e.g., a residual voltage) of the node p+. The discharge circuitry 210 may receive a voltage Vc indicating whether to reduce the voltage Vo of the node p+. A circuit diagram of the discharge circuitry 210 will be described in greater detail below with reference to FIGS. 3, 5, 6, 7, 8 and 9. A relationship between the voltage Vo and the voltage Vc will be described in greater detail below with reference to FIG. 4.

As described above, for driving the electronic component 230, a power signal (or a direct current signal) having the voltage Vo may be transmitted to the electronic component 230. The voltage Vo may be applied to the electronic component 230 for driving the electronic component 230. The discharge circuitry 210 may be positioned in an output end of the power circuitry 170 generating the power signal. The discharge circuitry 210 may substantially reduce the voltage Vo of the node p+ to 0 V according to the voltage Vc.

FIG. 3 is a circuit diagram illustrating an example configuration of discharge circuitry 210 included in an electronic device according to various embodiments. The electronic device 101 of FIG. 1 may include the discharge circuitry 210 of FIG. 3. The discharge circuitry 210 of FIG. 2 may have a structure described with reference to FIG. 3.

Referring to FIG. 3, the discharge circuitry 210 configured to receive a voltage Vo (e.g., the voltage Vo of the node p+ on the power path of FIG. 2) and a voltage Vc (e.g., the voltage Vc of FIG. 2) is illustrated. The voltage Vc may be applied to resistors R1 and R2 connected in series. The resistors R1 and R2 may operate as voltage divider circuitry for the voltage Vc. A capacitor C1 and a transistor Q2 may be connected to a node 350 between the resistors R1 and R2 connected in series. For example, an end of the capacitor C1 may be connected to the node 350, and another end of the capacitor C1 may be grounded. A gate electrode of the transistor Q2 may be connected to the node 350, and a source electrode may be grounded. The voltage Vc to which a ratio between resistance values of the resistors R1 and R2 is applied may be applied to the gate electrode of the transistor Q2. When the voltage (e.g., the voltage Vc to which the ratio is applied) applied to the gate electrode is greater than a threshold voltage (e.g., a threshold voltage for driving the transistor Q2), a drain electrode and the source electrode of the transistor Q2 may be electrically connected.

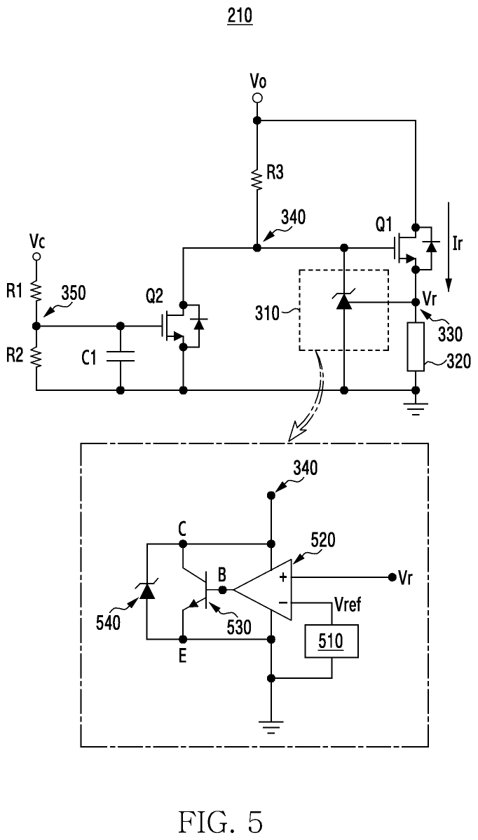

Referring to FIG. 3, the voltage Vo may be applied to a resistor R3 of the discharge circuitry 210 and a drain electrode of a transistor Q1. The resistor R3 may include an end to which the voltage Vo is applied and another end connected to a node 340. The node 340 may be electrically connected to the other end of the resistor R3, the drain electrode of the transistor Q2, and a gate electrode of the transistor Q1. The discharge circuitry 210 may include control circuitry 310 connected to the node 340 to control a voltage of the gate electrode of the transistor Q1. One or more circuitry elements included in the control circuitry 310 will be described in greater detail below with reference to FIGS. 5, 6, 7, 8 and 9 (which may be referred to as FIGS. 5 to 9).

The transistors Q1 and Q2, which are N-channel metal-oxide-semiconductor field effect transistors (N-MOSFETs), are illustrated as a switching element to control an electrical connection in the discharge circuitry 210, but the disclosure is not limited thereto. For example, another switching element such as a P-MOSFET, a metal-insulator-semiconductor FET (MISFET), a bipolar junction transistor (BJT), and/or a relay may be positioned in the discharge circuitry 210 interchangeably with the transistors Q1 and Q2. The transistors Q1 and Q2 and the other switching element that may be disposed on the transistors Q1 and Q2 may be referred to as switches. For example, the discharge circuitry 210 may include a switch (e.g., the transistor Q1) configured to (electrically) connect a thermistor 320 to a node (e.g., a node to which the voltage Vo is applied) included in a power path to transmit a power signal to an electronic component. For example, the switch (e.g., the transistor Q1) may be configured to control an electrical connection associated with the thermistor 320. The discharge circuitry 210 may include the control circuitry 310 configured to control the switch (e.g., the transistor Q1).

Referring to FIG. 3, the discharge circuitry 210 may include the thermistor 320 connected to the drain electrode or a source electrode of the transistor Q1. Although the thermistor 320 including an end connected to the source electrode of the transistor Q1 and another end which is grounded is illustrated, an embodiment is not limited thereto. Resistance (or a resistance value) of the thermistor 320 may depend on a temperature of the thermistor 320. For example, the thermistor 320 may have the resistance proportional to the temperature of the thermistor 320. For example, as the temperature of the thermistor 320 increases, the resistance of the thermistor 320 may increase. The thermistor 320 may be a positive temperature coefficient (PTC) thermistor.

In an embodiment, when the transistor Q1 is damaged, the voltage Vo may be fully applied to the thermistor 320 due to a short circuit in the transistor Q1. When receiving the voltage Vo, the temperature of the thermistor 320 may be rapidly increased. Since the resistance of the thermistor 320 is proportional to the temperature of the thermistor 320, overheating of the thermistor 320 may cause the resistance of the thermistor 320 to increase. Since a current of the thermistor 320 decreases when the resistance of the thermistor 320 increases, power consumption of the thermistor 320 may decrease and heat generation of the thermistor 320 may be limited. In other words, in spite of damage to the transistor Q1, the thermistor 320 may operate (stably) without the overheating that causes rapid overheating or damage to the thermistor 320.

A structure of the discharge circuitry 210 is not limited to the circuitry elements illustrated in FIG. 3. For example, at least one of the circuitry elements illustrated in FIG. 3 may be omitted or replaced with another suitable circuitry element. For example, the discharge circuitry 210 may further include a circuitry element not illustrated in FIG. 3. For example, the discharge circuitry 210 may include a Zener diode including a cathode connected to the gate electrode of the transistor Q1 and an anode which is grounded, as circuitry for protecting a voltage applied to the gate electrode of the transistor Q1 from a surge voltage.

The voltage Vc may be changed according to a state of the electronic device (e.g., the electronic device 101 of FIG. 1) including the discharge circuitry 210. The voltage Vc may be generated by the main circuitry 180 (or at least one processor included in the main circuitry 180 and configured to control an electronic component) of FIG. 1. For example, in a first state (e.g., the normal mode of FIG. 1) to activate an electronic component, the voltage Vc may be set such that a voltage (e.g., the voltage of the node 350) of the gate electrode of the transistor Q2 is greater than the threshold voltage for driving the transistor Q2. Referring to FIG. 3, since the transistor Q2 is activated by the voltage Vc in the first state, the gate electrode of the transistor Q1 connected to the node 340 may be electrically connected to a ground node through the transistor Q2. For example, the voltage of the gate electrode of the node 340 and/or the transistor Q1 may be reduced to a voltage (e.g., substantially 0 V) of the ground node. For example, the transistor Q1 may be deactivated in the first state. Since the transistor Q1 is deactivated, the thermistor 320 may not receive the voltage Vo. In other words, in the first state to activate the electronic component, the switch (e.g., the transistor Q1) may be controlled such that the thermistor 320 is electrically disconnected from a power path to which the voltage Vo is applied.

For example, in a second state (e.g., the standby mode of FIG. 1) to deactivate an electronic component, according to the voltage Vc, a voltage (e.g., the voltage of the node 350) of the gate electrode of the transistor Q2 may be reduced to less than the threshold voltage for driving the transistor Q2. Referring to FIG. 3, since the transistor Q2 is deactivated in the second state, the transistor Q1 connected to the node 340 may be electrically disconnected from a gate node connected to the source electrode of the transistor Q2. Since the transistor Q2 is deactivated, the voltage (e.g., the voltage of the node 340) of the gate electrode of the transistor Q1 may be increased to the voltage Vo applied through the resistor R3. When the voltage Vo is greater than the threshold voltage for driving the transistor Q1, the transistor Q1 may be activated. For example, in the second state, the transistor Q1 may be activated. Since the transistor Q1 is activated, the thermistor 320 may receive the voltage Vo. For example, a voltage Vr of a node 330, which is an end of the thermistor 320, may correspond to a difference between the voltage Vo and a potential difference Vds between the drain electrode and the source electrode of the transistor Q1 (Vr=Vo−Vds).

Referring to FIG. 3, the control circuitry 310 may be configured to receive or detect the voltage Vr of the node 330 between the transistor Q1 and the thermistor 320. Based on the voltage Vr, the control circuitry 310 may be configured to control the transistor Q1. For example, in the second state to deactivate the electronic component, the control circuitry 310 may be configured to control the switch (e.g., the transistor (Q1) such that a voltage of the thermistor 320 is maintained to be lower than or equal to a reference voltage.

For example, in a case that the voltage Vr of the node 330 is greater than the reference voltage (or in a case that the voltage Vr of the node 330 is greater than or equal to the reference voltage), the control circuitry 310 may electrically connect the node 340 and the ground node. When the control circuitry 310 electrically connects the node 340 and the ground node, the voltage of the node 340 may be substantially reduced to 0 V. Since the voltage of the gate electrode of the transistor Q1 connected to the node 340 is reduced to less than the threshold voltage for driving the transistor Q1, the transistor Q1 may be deactivated. For example, when the control circuitry 310 electrically connects the node 340 and the ground node, the thermistor 320 may be (electrically) disconnected or insulated from the power path to which the voltage Vo is applied.

For example, in a case that the voltage Vr of the node 330 is less than the reference voltage (or in a case that the voltage Vr of the node 330 is lower than or equal to the reference voltage), the node 340 and the ground node may be electrically disconnected in the control circuitry 310. Since the node 340 and the ground node are electrically disconnected, the voltage of the node 340 may depend on the voltage Vo unless the transistor Q2 is activated. In other words, for example, in a case that the voltage Vr of the node 330 is less than the reference voltage (or in a case that the voltage Vr of the node 330 is lower than or equal to the reference voltage), the transistor Q2 may be activated by the voltage Vo.

As described above, the control circuitry 310 may connect the thermistor 320 to a node (e.g., the node to which the voltage Vo is applied) on a power path by controlling the switch (e.g., the transistor Q1) to reduce a power signal transmitted through the power path (e.g., to reduce the voltage Vo of the power signal), based on deactivation of the electronic device including the discharge circuitry 210. The control circuitry 310 may be configured to control the switch such that the voltage of the thermistor 320 connected to the node is maintained to be lower than or equal to the reference voltage.

Referring to FIG. 3, in a state in which the transistor Q1 is activated, the voltage Vo may be applied to the transistor Q1 and the thermistor 320. For example, coupling of the voltage (e.g., Vds) between the drain electrode and the source electrode of the transistor Q1 and the voltage (e.g., Vr) of the thermistor 320 may correspond to the voltage Vo. In a case that the control circuitry 310 maintains the voltage of the thermistor 320 in a voltage range lower than or equal to the reference voltage, the voltage and/or a current of the thermistor 320 may be constantly maintained. Since the thermistor 320 receives a limited voltage and/or a limited current by the control circuitry 310, overheating of the thermistor 320 may be limited. Since the overheating of the thermistor 320 is limited, an increase in a resistance value of the thermistor 320 may be limited. Since the overheating of the thermistor 320 is limited, the discharge circuitry 210 including the thermistor 320 may be designed to have a reduced volume. When the voltage Vo is applied to the transistor Q1 and the thermistor 320, electrical energy having the voltage Vo in the transistor Q1 and the thermistor 320 may be changed into thermal energy.

For example, heat dissipation may occur in the transistor Q1 and the thermistor 320. To assist the heat dissipation, the discharge circuitry 210 may include a heat sink (or a heatsink) contacted to the transistor Q1. The heat sink may be attached onto a surface of the transistor Q1, and may be configured to dissipate heat on the surface. The heat sink may include a fluid medium (e.g., air and/or a liquid coolant). For example, the heat sink may have a cavity to accommodate the fluid medium and/or the liquid coolant. A side of an outer wall of the cavity may have a shape and/or a size to be contacted to the transistor Q1.

Hereinafter, a relationship between the voltage Vo transferred to the discharge circuitry 210, the voltage Vr of the thermistor 320, and a current Ir flowing from the drain electrode to the source electrode of the transistor Q1 will be described in greater detail below with reference to FIG. 4. By a series connection between the transistor Q1 and the thermistor 320, the current Ir flowing from the drain electrode to the source electrode of the transistor Q1 may match or correspond to the current of the thermistor 320.

FIG. 4 includes graphs illustrating a voltage and/or a current of a node and/or a circuitry element in an electronic device associated with discharge circuitry according to various embodiments. The discharge circuitry 210 of FIGS. 2 and/or 3 may include discharge circuitry of FIG. 4. The electronic device 101 of FIG. 1 may include the electronic device of FIG. 4.

Referring to FIG. 4, graphs 410, 420, and 430 corresponding to each of the voltage Vo, the voltage Vr, and the current Ir in the discharge circuitry of FIG. 3 are illustrated along a time axis. In a time period 401, the electronic device including the discharge circuitry may be in a normal mode. In the time period 401, a processor (e.g., including processing circuitry or control circuitry) configured to control an electronic component connected to the discharge circuitry may apply a voltage Vc to the discharge circuitry as in the graph 420. As described above with reference to FIG. 3, the discharge circuitry receiving the voltage Ve for driving a transistor Q2 may disconnect an electrical connection associated with the thermistor 320, by deactivating the transistor Q1.

In the time period 401 in which the electronic device is in the normal mode, a power signal having the voltage Vo may be transmitted to an electronic component (e.g., the electronic component 230 of FIG. 2) corresponding to the discharge circuitry, as in the graph 410. Based on the power signal, the electronic component may be activated. In the time period 401, the processor included in the electronic device may control the electronic component receiving the power signal.

The processor included in the electronic device may receive an input to deactivate the electronic device. The input may be identified or received based on a signal received through a remote controller (e.g., the remote controller 140 of FIG. 1) wirelessly connected to the electronic device. In response to the input, the processor may transmit a control signal indicating deactivation of the electronic device to control circuitry. For example, the processor that receives the input at a time point between time periods 401 and 402 may substantially reduce the voltage Vc to 0 V, as in the graph 420.

As described above with reference to FIG. 3, the transistor Q2 may be deactivated by the voltage Vc reduced to the 0 V. In the time period 402 after the transistor Q2 is deactivated, the control circuitry (e.g., the control circuitry 310 of FIG. 3) in the discharge circuitry may control a switch (e.g., the transistor Q1 of FIG. 3) such that the power signal having the voltage Vo transmitted to the electronic component is transmitted to the thermistor (e.g., the thermistor 320 of FIG. 3). The control circuitry may control the switch such that a voltage and/or a current of the power signal transmitted to the thermistor is maintained lower than or equal to a reference voltage and/or a reference current. For example, in a case that a voltage and/or a current of the thermistor is greater than or equal to the reference voltage and/or the reference current, the control circuitry may reduce the voltage and/or the current of the thermistor by controlling the switch. Referring to the graph 430, by the control circuitry, the current Ir of the thermistor may be maintained at Imax. In the time period 402, based on control of the switch by the control circuitry, the voltage Vr indicated by the graph 410 may be decreased linearly.

Since the current Ir of the thermistor is maintained at Imax in the time period 402, the thermistor may be controlled in a constant current (CC) method. The voltage Vr may also be linearly reduced by the thermistor controlled in the constant current manner. Electrical energy may be changed to thermal energy or dissipated not only in the thermistor but also in the switch (e.g., the transistor Q1 of FIG. 3) connected to the thermistor by the thermistor based on the constant current method.

Hereinafter, various example implementations of the discharge circuitry 210 of FIGS. 2 and/or 3 will be described in greater detail with reference to FIGS. 5 to 9.

FIG. 5 is a circuit diagram illustrating an example configuration of discharge circuitry 210 including a shunt regulator according to various embodiments. The electronic device 101 of FIG. 1 may include discharge circuitry 210 of FIG. 5. The discharge circuitry 210 of FIG. 5 may be an example of the discharge circuitry 210 of FIG. 2.

Referring to FIG. 5, the example circuit diagram of the discharge circuitry 210 including the shunt regulator is illustrated. For example, the control circuitry 310 of the discharge circuitry 210 may include a shunt regulator. The shunt regulator may include a voltage source 510, an operational amplifier (OP-AMP) 520, a BJT 530, and a Zener diode 540. The voltage source 510 may be configured to generate a reference voltage Vref (e.g., approximately 2.5 V) of the shunt regulator. The reference voltage Vref generated by the voltage source 510 may be applied to an inverted input electrode of the operational amplifier 520. A non-inverted input electrode of the operational amplifier 520 may be connected to a node 330 in the discharge circuitry 210. For example, a voltage Vr of the node 330 may be applied to the non-inverted input electrode.

Referring to FIG. 5, a voltage of the node 340 may be applied to the operational amplifier 520. While a transistor Q2 is deactivated, the voltage of the node 340 may increase to a voltage Vo. The operational amplifier 520 may be driven by the voltage Vo of the node 340. The node 340 may be connected to a collector electrode of the BJT 530. A cathode of the Zener diode may be connected to the node 340 and/or the collector electrode of the BJT 530. An anode of the Zener diode may be connected to an emitter electrode of the BJT 530 and/or a ground node. A base electrode of the BJT 530 may be connected to an output electrode of the operational amplifier 520. Although the BJT 530 of a NPN type is illustrated, an embodiment is not limited thereto, and a BJT of a PNP type may be included in the control circuitry 310.

Although an embodiment in which the operational amplifier 520 operates based on the voltage of the node 340 is described, the disclosure is not limited thereto. For example, the operational amplifier 520 may receive a power signal for driving the operational amplifier 520 from another node different from the node 340.

A current of the output electrode of the operational amplifier 520 may be determined based on a potential difference between the non-inverted input electrode and the inverted input electrode. For example, a current lamp of the output electrode of the operational amplifier 520 may have a relationship of lamp=A×(Vr−Vref) with respect to the voltage Vr of the non-inverted input electrode, the voltage Vref of the inverted input electrode, and a gain A of the operational amplifier 520. For example, in a case that the voltage Vr of the non-inverted input electrode is greater than the reference voltage Vref of the voltage source 510, the current lamp of the output electrode of the operational amplifier 520 may flow to the base electrode of the BJT 530.

A current may flow from the collector electrode to the emitter electrode of the BJT 530, by the current lamp flowing through the base electrode of the BJT 530. In other words, the collector electrode and the emitter electrode of the BJT 530 may be electrically connected. The voltage of the node 340 may be electrically connected to the ground node connected to the emitter electrode by the connection. For example, the voltage of the node 340 may be reduced to a voltage of the ground node. Since the node 340 is connected to a gate electrode of a transistor Q1, the transistor Q1 may be deactivated by a decrease in the voltage of the node 340.

In an embodiment of FIG. 5 including the shunt regulator as the control circuitry 310, a reference voltage of the control circuitry 310 causing deactivation of the transistor Q1 may correspond to the reference voltage Vref of the voltage source 510 in the shunt regulator. Although an example structure of the control circuitry 310 based on the shunt regulator is illustrated, the disclosure is not limited thereto. For example, other circuitry configured to perform a function of the control circuitry 310 described in FIGS. 3 and/or 5 may be included in the control circuitry 310.

As described above, the voltage of the thermistor 320 may be maintained as the reference voltage Vref of the voltage source 510 by the control circuitry 310 including the shunt regulator. Since the voltage of the thermistor 320 is maintained as the reference voltage Vref, according to Ohm's law, a current of the thermistor 320 may be maintained as Vref/Rptc with respect to a resistance Rptc of the thermistor 320. For example, the Imax of FIG. 4 may correspond to the Vref/Rptc.

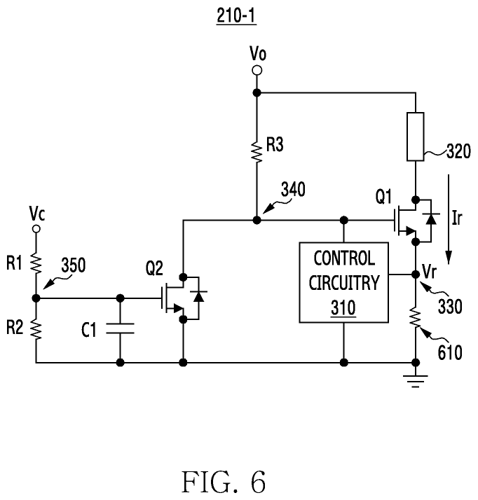

FIG. 6 is a circuit diagram illustrating example discharge circuitry included in an electronic device according to various embodiments. The electronic device 101 of FIG. 1 may include discharge circuitry 210-1 of FIG. 6. The discharge circuitry 210-1 of FIG. 6 may be an example of the discharge circuitry 210 of FIG. 2. Control circuitry 310 of FIG. 6 may include a shunt regulator described with reference to FIG. 5. Among descriptions of a circuitry element included in the discharge circuitry 210-1 of FIG. 6, a portion overlapping the descriptions of FIGS. 1 to 5 may not be repeated here.

Referring to FIG. 6, an embodiment in which a thermistor 320 directly receives a voltage Vo applied to the discharge circuitry 210-1 is illustrated. An end of the thermistor 320 may be connected to a node (e.g., the node p+ of FIG. 2) on a power path to which the voltage Vo is applied. Another end of the thermistor 320 may be connected to a drain electrode of a transistor Q1. The discharge circuitry 210-1 may include a resistor 610 including an end connected to a source electrode of the transistor Q1 and another end which is grounded.

As described above, a resistance value of the thermistor 320 may depend on a temperature of the thermistor 320. Referring to FIG. 6, independently of the dependency, in order to maintain magnitude of a current flowing through the thermistor 320 and/or the transistor Q1, the control circuitry 310 may detect or measure a voltage Vr of an end of the resistor 610. For example, the control circuitry 310 may control the transistor Q1 such that the voltage Vr is maintained as a reference voltage (e.g., the reference voltage Vref of the voltage source 510 of FIG. 5).

Since the control circuitry 310 activates or deactivates the transistor Q1, a current Ir at the thermistor 320, the transistor Q1, and the resistor 610 may be changed by the control circuitry 310. Since the control circuitry 310 maintains the voltage Vr of the resistor 610 as the reference voltage (e.g., the reference voltage Vref of the voltage source 510 of FIG. 5), the current Ir of the resistor 610 may be constantly maintained by Ohm's law. Referring to FIG. 6, since the current of the resistor 610 is constantly maintained, the current flowing through the transistor Q1 and/or the current of the thermistor 320 may be constantly maintained. For example, the current Ir may correspond to the Imax of FIG. 4.

As described above, in order to control the thermistor 320 in a constant current method, the discharge circuitry 210-1 may include the control circuitry 310 configured such that the resistor 610 receives the voltage Vr. Since the resistor 610 having a resistance value less sensitive to temperature is used instead of the thermistor 320 for switching of the transistor Q1 based on the control circuitry 310, the thermistor 320 having a larger resistance value may be included in the discharge circuitry 210-1. Since the resistance value of the thermistor 320 is increased, the current Ir flowing through the thermistor 320 may be limited according to the Ohm's law.

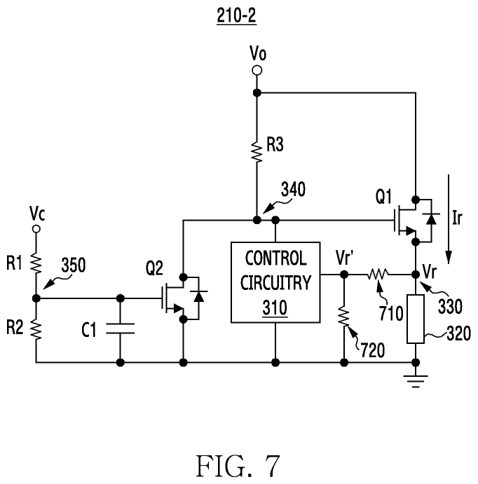

FIG. 7 is a circuit diagram illustrating example discharge circuitry included in an electronic device according to various embodiments. The electronic device 101 of FIG. 1 may include discharge circuitry 210-2 of FIG. 7. The discharge circuitry 210-2 of FIG. 7 may be an example of the discharge circuitry 210 of FIG. 2. Control circuitry 310 of FIG. 7 may include a shunt regulator described with reference to FIG. 5. Among descriptions of a circuitry element included in the discharge circuitry 210-2 of FIG. 7, a portion overlapping the description of FIGS. 1 to 6 may not be repeated here.

Referring to FIG. 7, the discharge circuitry 210-2 may include a resistor 710 including an end connected to a node 330 corresponding to an end of the thermistor 320 and a resistor 720 including an end connected to another end of the resistor 710 and another end which is grounded. The resistors 710 and 720 may operate as voltage divider circuitry for a voltage Vr of the node 330. For example, a voltage Vr′ between the resistors 710 and 720 may be a voltage in which the voltage Vr is reduced according to a ratio between resistance values of the resistors 710 and 720.

Referring to FIG. 7, the control circuitry 310 may be configured to receive the voltage Vr′. For example, the control circuitry 310 may be configured to control a transistor Q1 using the voltage Vr′ of a node between the resistors 710 and 720. The control circuitry 310 may control the transistor Q1 such that the voltage Vr′ is maintained as a reference voltage (e.g., the reference voltage Vref of the voltage source 510 of FIG. 5). Since the control circuitry 310 controls the transistor Q1 using the voltage Vr′ reduced from the voltage Vr, the transistor Q1 may be deactivated at the relatively large voltage Vr. By Ohm's law, a current Ir in the thermistor 320 may be increased since the voltage Vr increases. In other words, the thermistor 320 of the discharge circuitry 210-2 may receive a larger current than the thermistor 320 of the discharge circuitry 210 of FIG. 3. For example, the Imax of FIG. 4 may be increased.

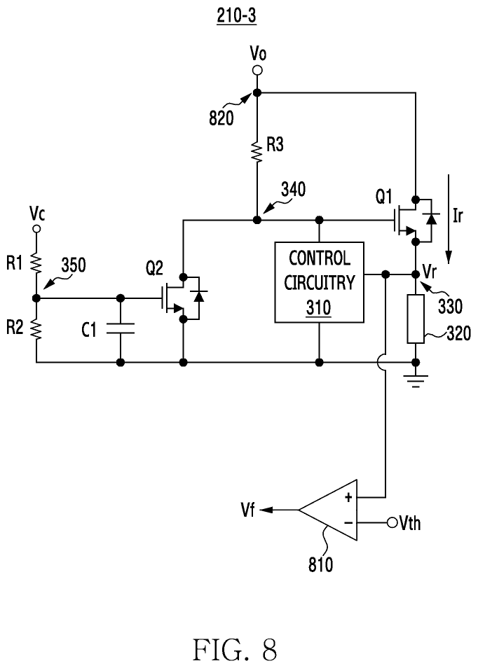

FIG. 8 is a circuit diagram illustrating example discharge circuitry included in an electronic device according to various embodiments. The electronic device 101 of FIG. 1 may include discharge circuitry 210-3 of FIG. 8. The discharge circuitry 210-3 of FIG. 8 may be an example of the discharge circuitry 210 of FIG. 2. Control circuitry 310 of FIG. 8 may include a shunt regulator described with reference to FIG. 5. Among descriptions of a circuitry element included in the discharge circuitry 210-3 of FIG. 8, a portion overlapping the description of FIGS. 1 to 7 may not be repeated here.

The voltage Vo applied to a node 820 in FIG. 8 may correspond to the voltage Vo in FIG. 3. Referring to FIG. 8, the discharge circuitry 210-3 may include an operational amplifier 810 connected to a node 330 between a thermistor 320 and the control circuitry 310. In an embodiment, the operational amplifier 810 may be included in the control circuitry 310. A threshold voltage Vth may be applied to an inverted input electrode of the operational amplifier 810. A voltage Vr of the node 330 may be applied to a non-inverted input electrode of the operational amplifier 810. The threshold voltage Vth may be determined as a voltage greater than a reference voltage (e.g., the reference voltage Vref of the voltage source 510 of the shunt regulator of FIG. 5) of the control circuitry 310. For example, the threshold voltage Vth may be set to detect an overcurrent flowing through the thermistor 320 by damage to the transistor Q1.

Similar to a characteristic of the operational amplifier 520 of FIG. 5, the operational amplifier 810 of FIG. 8 may also output a voltage Vf greater than 0 V when the voltage Vr applied to the non-inverted input electrode is greater than the voltage Vth of the inverted input electrode. The voltage Vf may be a fault signal indicating damage to the transistor Q1. For example, when the voltage Vr between a switch (e.g., a transistor Q1) and the thermistor 320 is greater the threshold voltage Vth, the operational amplifier 520 may transmit the fault signal having the voltage Vf. The fault signal may be used to deactivate the electronic device. For example, the fault signal may be transmitted to the main circuitry 180 (or a processor in the main circuitry 180) of FIG. 1. For example, the operational amplifier 520 may transmit the fault signal to deactivate the electronic device including the discharge circuitry 210-3. In other words, the discharge circuitry 210-3 including the operational amplifier 520 may deactivate the electronic device including the discharge circuitry 210-3 based on identifying that the voltage Vr applied to the thermistor 320 is greater than the threshold voltage Vth greater than the reference voltage (e.g., the reference voltage Vref of the shunt regulator of FIG. 5) for switching of the transistor Q1.

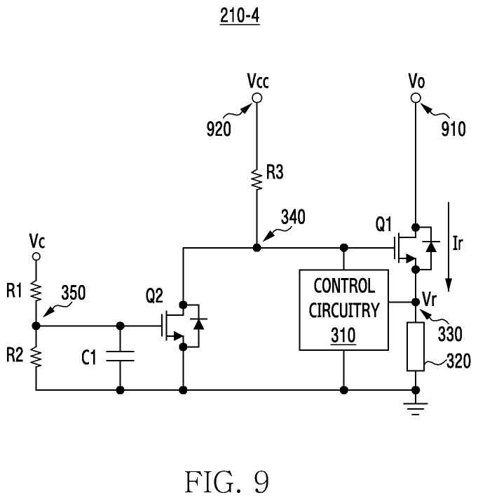

FIG. 9 is a circuit diagram illustrating example discharge circuitry included in an electronic device according to various embodiments. The electronic device 101 of FIG. 1 may include discharge circuitry 210-4 of FIG. 9. The discharge circuitry 210-4 of FIG. 9 may be an example of the discharge circuitry 210 of FIG. 2. Control circuitry 310 of FIG. 9 may include a shunt regulator described with reference to FIG. 5. Among descriptions of a circuitry element included in the discharge circuitry 210-4 of FIG. 9, a portion overlapping the description of FIGS. 1 to 8 may not be repeated here.

Referring to FIG. 9, the discharge circuitry 210-4 may receive a voltage Vcc for driving the control circuitry 310 through another node 920 different from a node 910 connected to a drain electrode of a transistor Q1. The voltage Vcc, which is a direct current voltage, may be provided based on the power circuitry 170 of FIG. 2. The voltage Vcc may be provided for discharging of a voltage Vo based on the control circuitry 310 while the electronic device including the discharge circuitry 210-4 is in a standby mode. An embodiment is not limited thereto, and the voltage Vcc may be provided (continuously) from the power circuitry 170 of FIG. 2.

Referring to FIG. 9, the voltage Vo may be applied to the node 910 connected to the drain electrode of the transistor Q1. The node 910 may be electrically connected to a node (e.g., the node p+ of FIG. 2) on a power path to which the voltage Vo is applied. The control circuitry 310 activated based on the voltage Vcc of the node 920 may detect or measure a voltage Vr of a node 330, which is an end of a thermistor 320. Using the voltage Vr, the control circuitry 310 may transmit a control signal indicating whether to activate the transistor Q1 to a gate electrode of the transistor Q1. The control signal may have a voltage less than a threshold voltage for driving the transistor Q1 or greater than or equal to the threshold voltage. For example, as it is determined to cause a current Ir to be zero by deactivating the transistor Q1 the control circuitry 310 may apply a direct current voltage less than the threshold voltage to the gate electrode of the transistor Q1. For example, as it is determined to generate a current transmitted from the drain electrode of the transistor Q1 to the thermistor 320 through a source electrode of the transistor Q1, by activating the transistor Q1, the control circuitry 310 may apply a direct current voltage greater than or equal to the threshold voltage to the gate electrode of the transistor Q1.

As described above with reference to FIGS. 1 to 8, the control circuitry 310 may change or determine a voltage of a control signal applied to the gate electrode of the transistor Q1 such that the voltage Vr of the node 330 is maintained as a reference voltage Vref of control circuitry 310 (e.g., the reference voltage Vref of the shunt regulator described with reference to FIG. 5). Since the voltage Vr of the node 330 is maintained as the reference voltage Vref (or another suitable direct current voltage), magnitude of a current of the thermistor 320 may be constantly maintained. Since the current of the thermistor 320 is constantly maintained, the discharge circuitry 210-4 may stably discharge the voltage Vo without (rapid) overheating of the thermistor 320.

As described above, according to an embodiment, discharge circuitry may include a thermistor. The discharge circuitry may include a switch to control an electrical connection of the thermistor, and control circuitry to control the switch. Heat dissipation in the thermistor and the switch may be controlled by the control circuitry. For example, a voltage and/or a current of the thermistor may be constantly maintained by the control circuitry and the switch.

In an embodiment, a method of more quickly reducing (or removing) a residual voltage of an electronic component included in an electronic device may be required. In an embodiment, a method of dissipating electrical energy of the electronic device using a thermistor may be required. In an embodiment, a method of controlling heat dissipation in the thermistor may be required. In an embodiment, a method of controlling a voltage and/or a current of the thermistor may be required. As described above, according to an embodiment, the electronic device (e.g., the electronic device 101 of FIG. 1) may comprise an electronic component (e.g., the electronic component 230 of FIG. 2). The electronic device may comprise a thermistor (e.g., the thermistor 320 of FIG. 3). A resistance of the thermistor may be increased by a temperature of the thermistor being increased. The electronic device may comprise a switch (e.g., the transistor Q1 of FIG. 3) configured to connect the thermistor to a node being included in a power path to transmit a power signal to the electronic component. The electronic device may comprise control circuitry (e.g., the control circuitry 310 of FIG. 3) configured to control the switch. The control circuitry may be configured to, based on deactivation of the electronic device, connect the thermistor to the node by controlling the switch to reduce the power signal transmitted through the power path. The control circuitry may be configured to control the switch such that a voltage of the thermistor connected to the node is maintained to be lower than or equal to a reference voltage. According to an embodiment, in the electronic device, the residual voltage of the electronic component may be reduced (or removed) more quickly. According to an embodiment, the electronic device may include the thermistor to dissipate the electrical energy of the electronic device. According to an embodiment, the electronic device may control the heat dissipation in the thermistor. According to an embodiment, the electronic device may control the voltage and/or the current of the thermistor.

For example, the switch may comprise a transistor including a drain electrode connected to the node, a source electrode connected to the thermistor, and a gate electrode electrically connected to the control circuitry.

For example, a heat sink contacted to the transistor may be comprised.

For example, a Zener diode including a cathode connected to the gate electrode and an anode which is grounded may be comprised.

For example, the control circuitry may comprise a shunt regulator.

For example, the control circuitry may comprise a first resistor including an end connected to a node between the switch and the thermistor. The control circuitry may comprise a second resistor including an end connected to another end of the first resistor and another end which is grounded. The shunt regulator may be configured to control the switch using a voltage of a node between the first resistor and the second resistor.

For example, the reference voltage may be a reference voltage of the shunt regulator.

For example, the control circuitry may be configured to compare a voltage between the switch and the thermistor, to a second reference voltage greater than a first reference voltage which is the reference voltage. The control circuitry may be configured to transmit, based on identifying that the voltage between the switch and the thermistor is greater than the second reference voltage, a fault signal to deactivate the electronic device.

For example, the electronic device may comprise a processor configured to control the electronic component. The processor may be configured to, in response to an input to deactivate the electronic device, transmit, to the control circuitry, a control signal indicating deactivation of the electronic device.

As described above, according to an embodiment, a method of operating an electronic device may be provided. The electronic device may comprise an electronic component, a thermistor, and a switch configured to control an electric connection associated with the thermistor. The method may comprise receiving an input to deactivate the electronic device. The method may comprise controlling, based on the input, the switch such that a power signal transmitted to the electronic component is transmitted to the thermistor. The method may comprise controlling, while the power signal is transmitted to the thermistor, the switch such that a voltage of the power signal transmitted to the thermistor is maintained to be lower than or equal to a reference voltage.

For example, the switch may comprise a transistor including a drain electrode connected to a node in a power path configured to transmit the power signal to the electronic component, a source electrode connected to the thermistor, and a gate electrode electrically connected to the control circuitry.

For example, the electronic device may comprise a heat sink contacted to the transistor.

For example, the electronic device may comprise a resistor including an end connected to the switch and another end which is grounded.

For example, the controlling the switch such that the voltage of the power signal is maintained to be lower than or equal to the reference voltage may comprise reducing, based on identifying the voltage of the power signal transmitted to the thermistor greater than or equal to the reference voltage, a current of the thermistor by controlling the switch.

For example, the reference voltage may be a first reference voltage. The method may comprise deactivating, based on identifying that the voltage of the power signal transmitted to the thermistor is greater than a second reference voltage greater than the first reference voltage, the electronic device.

As described above, according to an example embodiment, an electronic device may comprise power circuitry. The electronic device may comprise an electronic component. The electronic device may comprise a thermistor. A resistance of the thermistor may be increased by a temperature of the thermistor being increased. The electronic device may comprise a switch configured to connect the thermistor to a node being included in a power path to transmit a power signal from the power circuitry to the electronic component. The electronic device may comprise control circuitry configured to control the switch. The control circuitry may be configured to, in a first state to activate the electronic component, control the switch such that the thermistor is electrically disconnected from the power path. The control circuitry may be configured to, in a second state different from the first state, control the switch such that a voltage of the thermistor is maintained to be lower than or equal to a reference voltage.

For example, the control circuitry may be configured to, in the second state, connect the thermistor to the node by controlling the switch to reduce the power signal transmitted through the power path. The control circuitry may be configured to control the switch such that a voltage of the thermistor connected to the node is maintained to be lower than or equal to a reference voltage.

For example, the switch may comprise a transistor including a drain electrode connected to the node, a source electrode connected to the thermistor, and a gate electrode electrically connected to the control circuitry.

For example, the control circuitry may comprise a heat sink contacted to the transistor.

For example, the control circuitry may comprise a Zener diode including a cathode connected to the gate electrode and an anode which is grounded.

As used herein, the term “if” may, optionally, refer, for example, to “when” or “upon” or “in response to determining” or “in response to detecting,” depending on the context. Similarly, the phrase “if it is determined” or “if [a stated condition or event] is detected” may, optionally, refer, for example, to “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, and/or any other device capable of executing and responding to instructions. Thus, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various example embodiments have been described above with reference to various examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

What is claimed is:

1. An electronic device comprising:
an electronic component comprising circuitry;
a thermistor, wherein a resistance of the thermistor is configured to increase by a temperature of the thermistor being increased;
a switch configured to connect the thermistor to a node, wherein the node is included in a power path to transmit a power signal to the electronic component; and
control circuitry configured to control the switch,
wherein the control circuitry is configured to:
based on deactivation of the electronic device, connect the thermistor to the node by controlling the switch to reduce the power signal transmitted through the power path; and
control the switch such that a voltage of the thermistor connected to the node is maintained to be lower than or equal to a reference voltage.

2. The electronic device of claim 1, wherein the switch comprises,
a transistor including a drain electrode connected to the node, a source electrode connected to the thermistor, and a gate electrode electrically connected to the control circuitry.

3. The electronic device of claim 2, further comprising,
a heat sink contacting the transistor.

4. The electronic device of claim 2, further comprising,
a Zener diode including a cathode connected to the gate electrode and an anode which is grounded.

5. The electronic device of claim 1, wherein the control circuitry comprises a shunt regulator.

6. The electronic device of claim 5, wherein the control circuitry further comprises:
a first resistor including an end connected to a node between the switch and the thermistor;
a second resistor including an end connected to another end of the first resistor and another end which is grounded,
wherein the shunt regulator is configured to control the switch using a voltage of a node between the first resistor and the second resistor.

7. The electronic device of claim 5, wherein the reference voltage is a reference voltage of the shunt regulator.

8. The electronic device of claim 1, wherein the control circuitry is configured to:
compare a voltage between the switch and the thermistor, to a second reference voltage greater than a first reference voltage which is the reference voltage;
transmit, based on identifying that the voltage between the switch and the thermistor is greater than the second reference voltage, a fault signal to deactivate the electronic device.

9. The electronic device of claim 1, further comprising at least one processor, comprising processing circuitry, configured to control the electronic component,
wherein at least one processor, individually and/or collectively, is configured to cause the electronic device to:
in response to an input to deactivate the electronic device, transmit, to the control circuitry, a control signal indicating deactivation of the electronic device.

10. A method of operating an electronic device, wherein the electronic device comprises an electronic component, comprising circuitry, a thermistor, and a switch configured to control an electric connection associated with the thermistor, the method comprising:
receiving an input to deactivate the electronic device;
controlling, based on the input, the switch such that a power signal transmitted to the electronic component is transmitted to the thermistor; and
controlling, while the power signal is transmitted to the thermistor, the switch such that a voltage of the power signal transmitted to the thermistor is maintained to be lower than or equal to a reference voltage.

11. The method of claim 10, wherein the switch comprises,
a transistor including a drain electrode connected to a node in a power path configured to transmit the power signal to the electronic component, a source electrode connected to the thermistor, and a gate electrode electrically connected to the control circuitry.

12. The method of claim 11, wherein the electronic device further comprises,
a heat sink contacting the transistor.

13. The method of claim 10, wherein the electronic device further comprises,
a resistor including an end connected to the switch and another end which is grounded.

14. The method of claim 10, wherein the controlling the switch such that the voltage of the power signal is maintained to be lower than or equal to the reference voltage comprises:
reducing, based on identifying the voltage of the power signal transmitted to the thermistor greater than or equal to the reference voltage, a current of the thermistor by controlling the switch.

15. The method of claim 10, wherein the reference voltage is a first reference voltage, the method further comprising:
deactivating, based on identifying that the voltage of the power signal transmitted to the thermistor is greater than a second reference voltage greater than the first reference voltage, the electronic device.

16. An electronic device comprising:
power circuitry;
an electronic component comprising circuitry;
a thermistor, wherein a resistance of the thermistor is configured to increase by a temperature of the thermistor being increased;
a switch configured to connect the thermistor to a node, wherein the node is included in a power path to transmit a power signal from the power circuitry to the electronic component; and
control circuitry configured to control the switch,
wherein the control circuitry is configured to:
in a first state to activate the electronic component, control the switch such that the thermistor is electrically disconnected from the power path; and
in a second state different from the first state, control the switch such that a voltage of the thermistor is maintained to be lower than or equal to a reference voltage.

17. The electronic device of claim 16, wherein the control circuitry is configured to:
in the second state, connect the thermistor to the node by controlling the switch to reduce the power signal transmitted through the power path; and
control the switch such that a voltage of the thermistor connected to the node is maintained to be lower than or equal to a reference voltage.

18. The electronic device of claim 16, wherein the switch comprises,
a transistor including a drain electrode connected to the node, a source electrode connected to the thermistor, and a gate electrode electrically connected to the control circuitry.

19. The electronic device of claim 18, further comprising,
a heat sink contacting the transistor.

20. The electronic device of claim 18, further comprising,
a Zener diode including a cathode connected to the gate electrode and an anode which is grounded.
